(19) United States
(12) Patent Application Publication
(10) Pub. No.: US 2008/0250016 A1
(43) Pub. Date: Oct. 9, 2008

(54) OPTIMIZED SMITH-WATERMAN SEARCH

(76) Inventor: Michael Steven Farrar, Amherst, NH (US)

Correspondence Address: Vern Maine & Associates, 100 MAIN STREET, P O BOX 3445, NASHUA, NH, 03061-3445, US

(21) Appl. No.: 11/696,338

(22) Filed: Apr. 4, 2007

(51) Int. Cl. G06F 17/30

(52) U.S. Cl. 707/6

(57) ABSTRACT

An optimized database searching for a query sequence having a plurality of vectors arranged in a linear fashion, wherein the vectors are parallel to a query sequence, and a plurality of elements of the query sequence are reordered in a striped pattern, and wherein a set of dynamic programming scoring results are reported for further processing.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The invention relates to data searching, and more particularly in certain embodiments, to database searches, and in particular to genetic sequence database searching.

### BACKGROUND OF THE INVENTION

The general field of database searching has been the subject of much recent research, particularly in relation to the public sequence databases defining the genomes of living organisms. Many believe that the keys to understanding and curing many human diseases lie in the genetic sequence databases, and that faster and more accurate searching will aid in the development of new cures and answers to various diseases to benefit mankind. More particularly, searching databases for sequences that are similar to a given query sequence will enhance the understanding of the structural and functional properties of uncharacterized proteins.

In addition to the data searching in the bioinformatics field, the marketplace has shown the value of Internet database searching. Internet search engines such as Google have altered the Internet landscape and pioneered fast text searching from among vast data and ranking results according to certain criteria.

While there are a number of existing searching systems, there is always a struggle to improve sensitivity/accuracy of the search, while conducting the search in a timely manner. Even with the present computers, searching enormous databases tends to take a considerable amount of time and resources.

By way of example, the typical goal of a bioinformatic genetic sequence comparison algorithm is to note any statistically significant similarities between two or more genetically different sequences. For example, biological sequences, such as DNA, RNA, and protein sequences are typically stored as linear arrays of characters, where each character corresponds to a DNA, RNA, or protein base, element, or residue.

As the size of the GenBank/EMBL/DDBJ double every 15 months (Benson et al., 2000), faster implementations of the Smith-Waterman algorithm are needed to keep pace. One recent optimization has been adopting the algorithm to Single-Instruction Multiple-Data (SIMD) microprocessors. A SIMD instruction is able to perform the same operation on multiple pieces of data in parallel.

One of the first Smith-Waterman SIMD implementations was Alpern et al. (1995). This approach divided the 64-bit Z-buffer registers of the Intel Paragon i860 processor into four parts. Each part of the register contained a value from four different database sequences. A six fold speedup was achieved over the original implementation.

Wozniak (1997) presented an implementation of the Smith-Waterman algorithm running on the Sun Ultra SPARC using its SIMD instructions, the Visual Instruction Set. The SIMD registers contained values parallel to the minor diagonal. An advantage to this implementation is that there are no conditional branches in the inner loop. Therefore, the execution time is dependent on the length of the query string and the database, not the scoring matrix or gap penalties. A drawback of this implementation is the query profile must be computed for each database sequence. A speedup of over two times was reported over the traditional implementation.

Rognes and Seeberg (2000) presented an implementation of the Smith-Waterman algorithm running on the Intel Pentium processor using the MMX SIMD instructions. The SIMD registers contained values parallel to the query sequence. A major optimization was computing the query profile once for the entire database search. A disadvantage introduced by processing the values vertically is that conditional branches are placed in the inner loop to compute F.

The sensitivity of the algorithm is important in certain cases as there may be “faint” or less noticeable similarities between originally related sequences that have been altered by events such as mutation, insertion and deletion. These faint similarities can be easily over-looked unless the comparison is highly accurate.

A number of algorithms have been proposed which attempt to provide required sensitivity and speed for bioinformatics. Some algorithms emphasize computational speed while others maximize low-signal-detection ability. The Smith-Waterman algorithm is very sensitive and accurate, but typically takes an inordinate amount of time. Heuristic alternatives, such as FASTA (Pearson and Lipman, 1988), BLAST (Altschul et al., 1990, Altschul et al., 1997), and WU-BLAST (W. Gish, http://blast.wust1.edu) decrease the time requirements but trade-off sensitivity/accuracy.

The highly-sensitive Smith-Waterman algorithm is recursive and considers all possible alignments between two different target sequences. This comparison includes alignments. The recursive nature of the Smith-Waterman algorithm operates by building a history of prior best alignments for the comparisons. For illustrative purposes, an example of the Smith-Waterman processing is provided herein. The sequence comparison starts by considering an alignment between the first elements of two sequences being compared. It assigns a “score” based on the similarity and a zero score if there is no match. The algorithm continues processing and forms a matrix with cell locations that represents the score results.

For example, portions of two sequences with certain matches are illustrated as follows:
Sequence 1: . . . AYYUTOPPS . . .
Sequence 2: . . . YUYUTOPPZ . . .

In this example of the two ASCII character sequences, a matrix is formed for (Sequence 1)×(Sequence 2), wherein the value of each matrix cell represents some score that reflects the comparison using the Smith-Waterman processing. Once the processing is completed, a two dimensional matrix of potential Smith-Waterman alignments is constructed. A “best fit” sequence alignment is found by locating the matrix cell location with the best score. This approach has the disadvantages as detailed herein.

There are also been hardware implementations to address some of the noted problems described herein, however the hardware options tend to be costly. For example, one form of parallel processing termed Single-Instruction Multiple-Data (SIMD) enables microprocessors to perform the same operation in parallel on several independent data sources. The technology is included in some of the widely used modern microprocessors, including the Intel Pentium MMX, II and III. MMX (MultiMedia eXtensions) and SSE (Streaming SIMD Extensions) are forms of SIMD.

What is needed, therefore, are systems and techniques for providing sensitive data searching that can be done more efficiently in terms of computer processing.

### SUMMARY OF THE INVENTION

One embodiment of the invention is a system for a database search, comprising a striped Smith-Waterman implementation for comparing a query sequence to a database sequence, wherein the query sequence and the database sequence form a matrix having a plurality of vectors arranged in a linear fashion. The vectors are parallel to the query sequence, and a plurality of elements of the query sequence is reordered in a striped pattern. A Smith-Waterman algorithm is used to generate a set of dynamic programming results for further processing. The database search can be used for such functions as database searching and aligning sequences.

The striped pattern according to one embodiment comprises a plurality of partitions, wherein a length of the query sequence is divided by an equal number of partitions, the number of partitions is equal to the number of elements being processed in the vectors, and wherein the n^{th} vector processes the nth values from each partition.

A further feature includes a query profile that is pre-calculated once for the database search by reordering a set of weights to match the striped pattern over which the query sequence is processed.

In another embodiment, an F value is set to an initial value for out of order calculations. A secondary loop can be used to correct errors introduced by the initial F value.

An additional feature includes scoring wherein the scoring uses a scoring function selected from one of the group consisting of: block substitution, position-specific scoring matrices (PSSM) and profile hidden Markov model (profile HMM). In one variation, the scoring generates a table of weights using a substitution matrix, and a scoring profile is indexed by a query sequence position and a database sequence symbol.

In accordance with one embodiment, the query sequence is reordered in the striped pattern, and is used to generate a shuffle profile, wherein the shuffle profile creates a substitution matrix to match the striped pattern of the query string.

In one aspect, a row of the substitution matrix matches a current database sequence symbol and the shuffle pattern is indexed by a query sequence position, wherein computing of H consists of a single load from memory of a shuffle vector from the shuffle profile.

An embodiment of the invention is a method for dynamic programming, comprising initializing memory for a scoring profile, building the scoring profile based on a query string by reordering a plurality of elements of the query string in a striped pattern, wherein the scoring profile is used once for an entire search, performing the dynamic programming processing in the striped pattern, and reporting a set of scoring results from the dynamic programming for interpretation or alignment.

Another feature comprises setting each F vector initial values that have not been calculated, and further comprising correcting errors based on incorrect initial values.

According to one embodiment, the invention comprises computing at least one of an optimal local alignment and a global alignment.

The dynamic programming in accordance with one embodiment uses an algorithm selected from the group consisting of: Smith-Waterman, Needleman-Wunsch, Gotoh, and Viterbi.

A further embodiment is a computer storage medium readable by a computer system having computer-executable components for a database search, comprising processing a plurality of vectors arranged in a linear fashion, wherein the vectors are parallel to a query sequence, building a scoring profile based on the query sequence by reordering a plurality of elements of the query sequence to match a striped pattern, wherein the scoring profile is used once for the database search. Dynamic programming of the striped pattern is used to produce a set of scoring results, and the scoring results are reported.

Another feature comprises reporting of a location of a scoring sequence of the scoring results.

In a further variant, the data dependencies of the vectors are moved out of an inner loop and done just once in an outer loop.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1a is a prior art depiction of the Wozniak implementation.

FIG. 1b is a prior art illustration of the data dependency of the Wozniak implementation.

FIG. 2a is a prior art depiction of the Rognes implementation.

FIG. 2b is a prior art illustration of the data dependency of the Rognes implementation.

FIG. 3 is an illustration of the striped Smith-Waterman implementation according to one embodiment.

FIG. 4 is an illustration showing the striped Smith-Waterman data dependencies between the last H vector and the first H vector of the next column according to one embodiment.

FIG. 5 is an illustration showing the data dependencies between the last F vector and the first F vector according to one embodiment.

FIG. 6 is a flowchart presentation for generating the scoring profile according to one embodiment.

FIG. 7 is a flowchart for the Smith-Waterman calculation according to one embodiment.

FIG. 8 is a flowchart for generating the E and H loop correction according to one embodiment.

FIG. 9 graphically depicts the processing speeds for different Smith-Waterman implementations with one scoring matrix.

FIG. 10 graphically depicts the processing speeds for different Smith-Waterman implementations with another scoring matrix.

FIG. 11 graphically depicts the complete database search times for different Smith-Waterman implementations using different gap penalties.

FIG. 12 graphically shows the speeds for different algorithms.

FIG. 13 graphically shows a byte shuffle (permute) operation according to one embodiment.

### DETAILED DESCRIPTION

In general terms, the present invention is an improved system for comparing two sequences. For terminology purposes, the term sequence refers to a list of elements of any size, wherein the elements can be any form of data that is consistent. For example, the data can be American Standard Code for Information Interchange (ASCII) strings, Extended Binary Coded Decimal Interchange Code (EBCDIC) strings, and voice samplings. The term query sequence refers to the sequence for which the comparison is desired and includes portions of a much larger target query sequence. Likewise, a database sequence refers to the sequence that is being used for comparison to the query sequence and includes a portion of a much larger target database sequence.

As noted herein, the Smith-Waterman algorithm is one of the algorithms used for comparing sequences and is based on the general concept of dynamic programming which refers to a way of solving problems where you need to find the best decisions one after another. In the typical dynamic programming, the value of the current cell is dependent on the values in other cells. For example, according to one of the known implementations the value of the current cell is dependent upon the cell above, the cell along the major diagonal (above and to the left) and the cell to the left. This requirement generally leads to a strict order in which the cells are processed. While the invention is described in terms of the Smith-Waterman algorithm, other dynamic programming algorithms, including hybrids of these algorithms are within the scope of the invention.

When vectorizing, two approaches have typically been utilized. One such implementation by Wozniak loads the vectors along the minor diagonal. A second implementation by Rognes which is described in U.S. Publication Nos. 2004/0098203A1 and 2004/0024536A1 loads the vectors parallel to the query string. Both of the implementations employ algorithms that process the cells in the order of their dependencies.

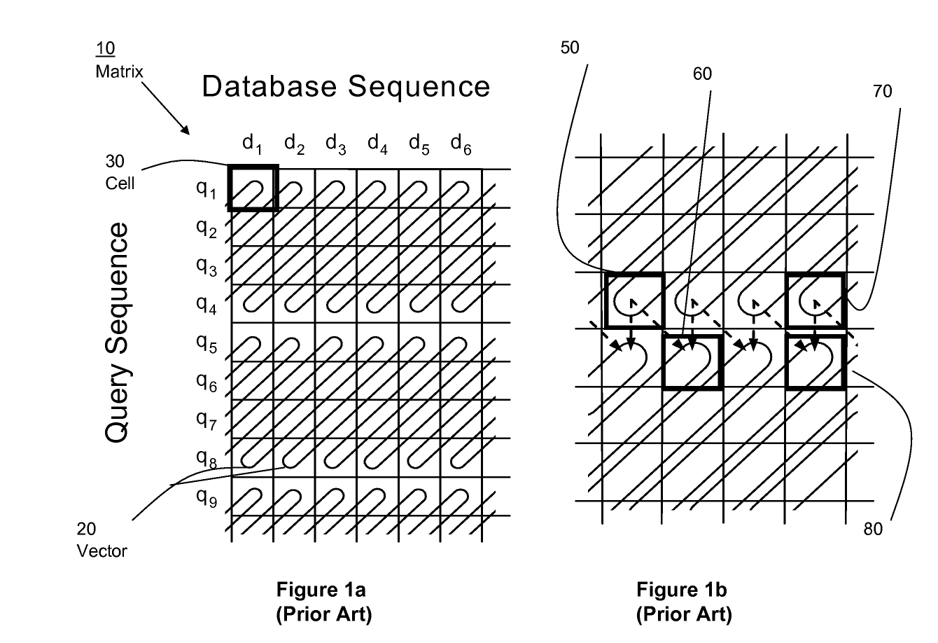

Referring to FIG. 1a, the matrix array 10 shows the query sequence q₁-q₉ and the database sequence d₁-d₆. The Wozniak implementation loads the vectors 20 along the minor diagonal of the search matrix 10. Before the current vector is processed, the vector above, on the major diagonal and to the left are computed. This allows the cells 30 to be processed in the correct order.

This approach has several disadvantages. The first drawback is the scoring profile cannot be pre-computed for the search. Before the H vector can be calculated, a vector needs to be loaded with the weights for each comparison. This building of the weight vector is done for each vector of the database.

Another drawback is the data dependencies between the vectors as illustrated in FIG. 1b. The H vector affects the next vector along the major diagonal. For illustrative purposes, this requires that the last element of the previous H vector 50 to be inserted into the first element of the current H vector 60. This is also true of the F vector. The last element from the F vector 70 above needs to be inserted into the first element of the current F vector 80.

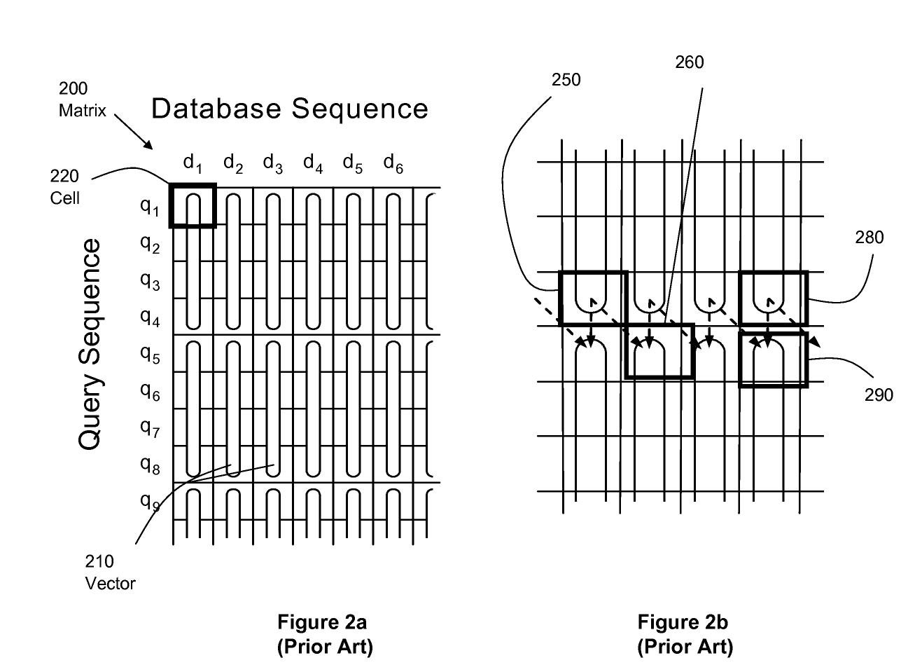

The Rognes implementation loads the vectors 210 parallel to the query string for the matrix 200 as shown in FIG. 2a. Before the current vector is processed, the vector above, on the major diagonal and to the left are computed which allows the cells 220 to be processed in the correct order. The major advantage of the Rognes over Wozniak is the query profile can be computed once for an entire database search.

However, the Rognes approach has two drawbacks, namely, the data dependencies between vectors and the calculations of F require conditional code in the inner loop.

The first draw back is the data dependencies between the vectors as shown in FIG. 2b. The H vector affects the next vector along the major diagonal. This requires that the last element of the previous H vector 250 to be inserted into the first element of the current H vector 260. This is also true of the F vector. The last element from the F vector above 280 needs to be inserted into the first element of the current F vector 290.

Another drawback of this implementation is the F calculation in the inner loop. The gap penalty is subtracted from the F vector. If any elements in the F vector are greater than zero, the F vector can affect the H values and needs to be calculated. This is done by shifting the F vector 1 element, subtracting the gap penalty and then taking the maximum of the result. This is repeated until all elements in the vector are zero. This code places branches in the inner loop to check if the F calculations are necessary. These branches introduce stalls in the execution pipeline affecting the execution times.

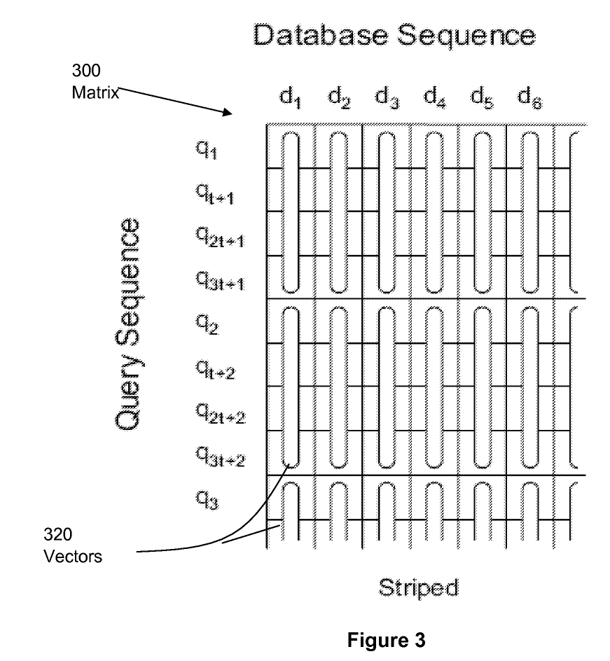

According to one embodiment of the present invention, the vectors run parallel to the query sequence and the processing accesses the query in a striped pattern. Referring to the Striped Smith-Waterman implementation of FIG. 3, the memory layout for the query profile is similar to the Rognes implementation of FIG. 2a, wherein the vectors 320 run parallel to the query sequence. However, the striped implementation in this embodiment reorders the query in a striped pattern unlike the sequential access for Rognes. The striped Smith-Waterman implementation in one embodiment pre-calculates the query profile.

As noted herein, both the Wozniak and Rognes implementations have data dependencies between the previous H vector and the current H vector as well as the prior F vector and current F vector. In distinction, the striped query reordering according to one embodiment moves these data dependencies out of the inner loop and they are done just once in the outer loop when processing the next database residue. Thus the elements of the vectors 320 are not data dependent upon the previous vector elements.

### STRIPED SMITH-WATERMAN EXAMPLE

For this striped Smith-Waterman example of a protein search, the SIMD register size is three elements per register, p=3. The alphabet for this example is defined as A={A, C, G, T}. The following two sequences Q=“CCGTAGGAT” and D=“CGT” are compared. The penalty values for opening a gap (Gᵢₙᵢₜ) and extending a gap (Gₑₓₜ) are −10 and −2 respectively. The scoring matrix used is:

TABLE 1

| | A | C | G | T |
|---|---|---|---|---|
| A | 7 | 1 | −4 | −2 |
| C | 1 | 10 | −4 | −6 |
| G | −4 | −4 | 4 | 0 |
| T | −2 | −6 | 0 | 6 |

### Scoring Profile

As detailed herein, a query sequence is typically compared to many different database sequences. However, a simple improvement is to generate a table of the weights specific for the query sequence for each possible protein using the substitution matrix. Instead of indexing the substitution matrix by the query sequence symbol and the database sequence symbol, the scoring profile is indexed by the query sequence position and the database sequence symbol. Now computing of H consists of a single load from memory of the weights from the scoring profile and an add instruction.

The scoring profile is computed once for the entire search. One of the first steps is to calculate the number of vectors, t, needed to process the query string, Q (Q=“CCGTAGGAT”). This number is also the length of each segment.

TABLE 2

t = int((|Q| + (p − 1))/p)
t = int((9 + 2)/3
t = 3

The query segments are processed by dividing Q into p equal length segments, S. The query segments are defined as Sₙ=qₜ₍ₙ₋₁₎₊₁, qₜ₍ₙ₋₁₎₊₂, . . . , qₜ₍ₙ₋₁₎₊ₜ. Each element of the SIMD register is used to calculate the values from one segment. The values for S are:

TABLE 3

| | | | |
|---|---|---|---|
| S₁ = | C | C | G |
| S₂ = | T | A | G |
| S₃ = | G | A | T |

Since the SIMD registers map to the i^{th} element of each segment, the first SIMD register will map to the sequence “CTG”. Using the scoring matrix above, the weights from the scoring matrix for “A” for the first SIMD register are <1, −2, −4>. The weights are typically supplied from the substitution matrix and can be, for example, based on the probability of that letter being in the database. For the second segment, “CAA”, the weights are <1, 7, 7>. Continuing this for the remaining segment, “GGT”, the scoring profile for “A” is:

TABLE 4

| | A |
|---|---|
| C | 1 |
| T | −2 |
| G | −4 |
| C | 1 |
| A | 7 |
| A | 7 |
| G | −4 |
| G | −4 |
| T | −2 |

Continue building the scoring profile for all the remaining letters in the alphabet, {C, G, T} The scoring profile for query string Q for the complete alphabet A is:

TABLE 5

| | A | C | G | T |
|---|---|---|---|---|
| C | 1 | 10 | −4 | −6 |
| T | −2 | −6 | 0 | 6 |
| G | −4 | −4 | 4 | 0 |
| C | 1 | 10 | −4 | −6 |
| A | 7 | 1 | −4 | −2 |
| A | 7 | 1 | −4 | −2 |
| G | −4 | −4 | 4 | 0 |
| G | −4 | −4 | 4 | 0 |
| T | −2 | −6 | 0 | 6 |

### Striped Smith-Waterman Calculation

The Smith-Waterman calculation uses the dynamic programming algorithm, and this example shows this calculation using SIMD instructions accessing the query sequence Q in an out of order access pattern. The cells in the example have the following format:

TABLE 6

| | F |
|---|---|
| E | H |

The steps to calculate a cell's value using the Striped Smith-Waterman used by this example are as follows:

| | |
|---|---|
| (1) H = H + W | // Add weights to the H vector |
| (2) H = Max (H, E) | // Use scores from E if higher |
| (3) H = Max (H, F) | // Use scores from F if higher |
| (4) H′ = H − Ginit | // Subtract the gap init penalty |
| (5) E = E − Gext | // Subtract the gap extension penalty |
| (6) E = Max (E, H′) | // Check if starting or extending gap |
| (7) F = F − Gext | // Subtract the gap extension penalty |
| (8) F = Max (F, H′) | // Check if starting or extending gap |

The steps to correct any errors introduced by the initial F value using the Striped Smith-Waterman used by this example are noted below:

| | |
|---|---|
| (9) F = Shift (F, 1) | // Shift F elements over for the next column |
| (10) H′ = H − Ginit | // Find the lowest H threshold |
| (11) while (Cmp_gt(F,H′)) | // Repeat loop while any element in F > H′ |
| (12) H = Max (H, F) | // Use scores from F if higher |
| (13) F = F − Gext | // Subtract the gap extension penalty |

The processing commences by initializing the E vectors to all zeros. The F vector is also initialized to zero. The initial F vector processes the first values from each segment, i.e. <F>={q₁, q₄, q₇}.

For a normal dynamic programming implementation, the value from the cell above the current cell is used to compute the value of the current cell. Since values for cells q₃ and q₆ (the cells above q₄ and q₇) are unknown, their values will be assumed to be zero. If this assumption is incorrect, the values will be corrected in a second pass. After the first two step, the values of the table are indicated below in Table 7. The table on the left shows the cells computed out of order per the query sequence and on the right shows the transformed order used by the vector registers.

TABLE 7

| | | | | | |
|---|---|---|---|---|---|
| C | G | T | C | G | T |

| | | | | | |
|---|---|---|---|---|---|
| C | | 0 | C | | 0 |
| | 0 | | | 0 | |
| C | | | T | | 0 |
| | 0 | | | 0 | |
| G | | | G | | 0 |
| | 0 | | | 0 | |
| T | | 0 | C | | |
| | 0 | | | 0 | |
| A | | | A | | |
| | 0 | | | 0 | |
| G | | | A | | |
| | 0 | | | 0 | |
| G | | 0 | G | | |
| | 0 | | | 0 | |
| A | | | G | | |
| | 0 | | | 0 | |
| T | | | T | | |
| | 0 | | | 0 | |

The H value is calculated for the first vector of the “C” column. From the pre-computed scoring profile, add the first weight vector for “C” to <H>. Since this is the first column, all H values are zero. Saturated math is used, so no values will be less than 0.

(1) <10, −6, −4>+<0, 0, 0>=<10, 0, 0>

Set H to the maximum value of E and H.

(2) Max(<0, 0, 0>, <10, 0, 0>)=<10, 0, 0>

Set H to the maximum value of F and H.

(3) Max(<0, 0, 0>, <10, 0, 0>)=<10, 0, 0>

Calculate the new H score is starting a new gap.

(4) <10, 0, 0>−<10, 10, 10>=<0, 0, 0>

Then, calculate the E values for the next column over.

(5) <0, 0, 0>−<2, 2, 2>=<0, 0, 0>

(6) Max(<0, 0, 0>, <0, 0, 0>)=<0, 0, 0>

Calculate the F values for the next row down.

(7) <0, 0, 0>−<2, 2, 2>=<0, 0, 0>

(8) Max(<0, 0, 0>, <0, 0, 0>)=<0, 0, 0>

Performing the steps above generates Table 8 below.

TABLE 8

| | | | | | |
|---|---|---|---|---|---|
| C | G | T | C | G | T |

| | | | | | | | |
|---|---|---|---|---|---|---|---|
| C | | 0 | | C | | 0 | |
| | 0 | 10 | 0 | | 0 | 10 | 0 |
| C | | 0 | | T | | 0 | |
| | 0 | | | | 0 | 0 | 0 |
| G | | | | G | | 0 | |
| | 0 | | | | 0 | 0 | 0 |
| T | | 0 | | C | | 0 | |
| | 0 | 0 | 0 | | 0 | | |
| A | | 0 | | A | | 0 | |
| | 0 | | | | 0 | | |
| G | | | | A | | 0 | |
| | 0 | | | | 0 | | |
| G | | 0 | | G | | | |
| | 0 | 0 | 0 | | 0 | | |
| A | | 0 | | G | | | |
| | 0 | | | | 0 | | |
| T | | | | T | | | |
| | 0 | | | | 0 | | |

The process continues the calculation of H for the next vector “CAA” of the “C” column. From the pre-computed scoring profile, add the second weight vector for “C” to <H>. The steps 1-8 are repeated with the new values.

(1) <10, 1, 1>+<0, 0, 0>=<10, 1, 1>

(2) Max(<0, 0, 0>, <10, 1, 1>)=<10, 1, 1>

(3) Max(<0, 0, 0>, <10, 1, 1>)=<10, 1, 1>

(4) <10, 1, 1>−<10, 10, 10>=<0, 0, 0>

(5) <0, 0, 0>−<2, 2, 2>=<0, 0, 0>

(6) Max(<0, 0, 0>, <0, 0, 0>)=<0, 0, 0>

(7) <0, 0, 0>−<2, 2, 2>=<0, 0, 0>

(8) Max(<0, 0, 0>, <0, 0, 0>)=<0, 0, 0>

Performing the steps above generates Table 9 below.

TABLE 9

| | | | | | |
|---|---|---|---|---|---|
| C | G | T | C | G | T |

| | | | | | | | |
|---|---|---|---|---|---|---|---|
| C | | 0 | | C | | 0 | |
| | 0 | 10 | 0 | | 0 | 10 | 0 |
| C | | 0 | | T | | 0 | |
| | 0 | 10 | 0 | | 0 | 0 | 0 |
| G | | 0 | | G | | 0 | |
| | 0 | | | | 0 | 0 | 0 |
| T | | 0 | | C | | 0 | |
| | 0 | 0 | 0 | | 0 | 10 | 0 |
| A | | 0 | | A | | 0 | |
| | 0 | 1 | 0 | | 0 | 1 | 0 |
| G | | 0 | | A | | 0 | |
| | 0 | | | | 0 | 1 | 0 |
| G | | 0 | | G | | 0 | |
| | 0 | 0 | 0 | | 0 | | |
| A | | 0 | | G | | 0 | |
| | 0 | 1 | 0 | | 0 | | |
| T | | 0 | | T | | 0 | |
| | 0 | | | | 0 | | |

Continue the calculation of H for the next vector “GGT” of the “C” column. From the pre-computed scoring profile, add the third weight vector for “C” to <H>. Steps 1-8 are repeated with the new values.

(1) <−4, −4, −6>+<0, 0, 0>=<0, 0, 0>

(2) Max(<0, 0, 0>, <0, 0, 0>)=<0, 0, 0>

(3) Max(<0, 0, 0>, <0, 0, 0>)=<0, 0, 0>

(4) <0, 0, 0>−<2, 2, 2>=<0, 0, 0>

(5) <0, 0, 0>−<10, 10, 10>=<0, 0, 0>

(6) Max(<0, 0, 0>, <0, 0, 0>)=<0, 0, 0>

(7) <0, 0, 0>−<10, 10, 10>=<0, 0, 0>

(8) Max(<0, 0, 0>, <0, 0, 0>)=<0, 0, 0>

Performing the steps above generates Table 10 below.

TABLE 10

| | | | | | |
|---|---|---|---|---|---|
| C | G | T | C | G | T |

| | | | | | | | |
|---|---|---|---|---|---|---|---|
| C | | 0 | | C | | 0 | |
| | 0 | 10 | 0 | | 0 | 10 | 0 |
| C | | 0 | | T | | 0 | |
| | 0 | 10 | 0 | | 0 | 0 | 0 |
| G | | 0 | | G | | 0 | |
| | 0 | 0 | 0 | | 0 | 0 | 0 |
| T | | 0 | | C | | 0 | |
| | 0 | 0 | 0 | | 0 | 10 | 0 |
| A | | 0 | | A | | 0 | |
| | 0 | 1 | 0 | | 0 | 1 | 0 |
| G | | 0 | | A | | 0 | |
| | 0 | 0 | 0 | | 0 | 1 | 0 |
| G | | 0 | | G | | 0 | |
| | 0 | 0 | 0 | | 0 | 0 | 0 |
| A | | 0 | | G | | 0 | |
| | 0 | 1 | 0 | | 0 | 0 | 0 |
| T | | 0 | | T | | 0 | |
| | 0 | 0 | 0 | | 0 | 0 | 0 |

Now that all the column calculations are done, a check will be done to see if any errors were introduced by the initial F values being zero.

Shift the last F vector to the right by one element. The last F vector has the last elements from each of the segments, i.e. <F>={q₃, q₆, q₉}. These values need to be compared to the first <H> vector, i.e. {q₁, q₄, q₇}, so contents need to be shifted so the elements are aligned in the SIMD registers.

(9) Shift(<0, 0, 0>, 1)=<0, 0, 0>

Check if any elements in <F> are greater than the first <H> vector minus Gᵢₙᵢₜ.

(10) <10, 0, 0>−<10, 10, 10>=<0, 0, 0>

(11) Cmp_gt(<0, 0, 0>, <0, 0, 0>)=FALSE

Since no values in <F> are greater than <H′>, the initial assumption for the value of <F> did not introduce any errors. The loop to correct any error is skipped and the next column is calculated.

Now continue to Smith-Waterman calculations on the next column “G”. Initialize the F vector to zero. The initial F vector is processing the first values from each segment, i.e. <F>={q₁, q₄, q₇}.

Load the H values for the first vector of the “G” column. To calculate the first H, the weight is added to the H value that is to the left and up one cell. The first vector is processing cells {q₁, q₄, q₇}. To get the H values to the left and up one, the last H vector, containing cells {q₃, q₆, q₉}, is loaded and its contents are shifted right by one element.

Shift(<0, 0, 0>, 1)=<0, 0, 0>

Add the weight to the H vector.

(1) <−4, 0, 4>+<0, 0, 0>=<0, 0, 4>

Set H to the maximum value of E and H.

(2) Max(<0, 0, 0>, <0, 0, 4>)=<0, 0, 4>

Set H to the maximum value of F and H.

(3) Max(<0, 0, 0>, <0, 0, 4>)=<0, 0, 4>

Calculate the new H score is starting a new gap.

(4) <0, 0, 4>−<10, 10, 10>=<0, 0, 0>

Calculate the E values for the next column over.

(5) <0, 0, 0>−<2, 2, 2>=<0, 0, 0>

(6) Max(<0, 0, 0>, <0, 0, 0>)=<0, 0, 0>

Calculate the F values for the next column over.

(7) <0, 0, 0>−<2, 2, 2>=<0, 0, 0>

(8) Max(<0, 0, 0>, <0, 0, 0>)=<0, 0, 0>

Performing the steps of above generates Table 11 below.

TABLE 11

| | C | | G | | T | | C | | G | | T |
|---|---|---|---|---|---|---|---|---|---|---|---|
| C | | 0 | | 0 | | C | | 0 | | 0 | |
| | 0 | 10 | 0 | 0 | 0 | | 0 | 10 | 0 | 0 | 0 |
| C | | 0 | | 0 | | T | | 0 | | 0 | |
| | 0 | 10 | 0 | | | | 0 | 0 | 0 | 0 | 0 |
| G | | 0 | | | | G | | 0 | | 0 | |
| | 0 | 0 | 0 | | | | 0 | 0 | 0 | 4 | 0 |
| T | | 0 | | 0 | | C | | 0 | | 0 | |
| | 0 | 0 | 0 | 0 | 0 | | 0 | 10 | 0 | | |
| A | | 0 | | 0 | | A | | 0 | | 0 | |
| | 0 | 1 | 0 | | | | 0 | 1 | 0 | | |
| G | | 0 | | | | A | | 0 | | 0 | |
| | 0 | 0 | 0 | | | | 0 | 1 | 0 | | |
| G | | 0 | | 0 | | G | | 0 | | | |
| | 0 | 0 | 0 | 4 | 0 | | 0 | 0 | 0 | | |
| A | | 0 | | 0 | | G | | 0 | | | |
| | 0 | 1 | 0 | | | | 0 | 0 | 0 | | |
| T | | 0 | | | | T | | 0 | | | |
| | 0 | 0 | 0 | | | | 0 | 0 | 0 | | |

Now continue to Smith-Waterman calculations for the next vector in the “G” column. Calculate the H value for the second vector of the “G” column. From the pre-computed scoring profile, add the second weight vector for “G” to previous <H> vector from the “C” column.

(1) <−4, −4, −4>+<10, 0, 0>=<6, 0, 0>

Set H to the maximum value of E and H.

(2) Max(<0, 0, 0>, <6, 0, 0>)=<6, 0, 0>

Set H to the maximum value of F and H.

(3) Max(<0, 0, 0>, <6, 0, 0>)=<6, 0, 0>

Calculate the new H score is starting a new gap.

(4) <6, 0, 0>−<10, 10, 10>=<0, 0, 0>

Calculate the E values for the next column over.

(5) <0, 0, 0>−<2, 2, 2>=<0, 0, 0>

(6) Max(<0, 0, 0>, <0, 0, 0>)=<0, 0, 0>

Calculate the F values for the next column over.

(7) <0, 0, 0>−<2, 2, 2>=<0, 0, 0>

(8) Max(<0, 0, 0>, <0, 0, 0>)=<0, 0, 0>

Performing the steps above generates Table 12 below.

TABLE 12

| | C | | G | | T | | C | | G | | T |
|---|---|---|---|---|---|---|---|---|---|---|---|
| C | | 0 | | 0 | | C | | 0 | | 0 | |
| | 0 | 10 | 0 | 0 | 0 | | 0 | 10 | 0 | 0 | 0 |
| C | | 0 | | 0 | | T | | 0 | | 0 | |
| | 0 | 10 | 0 | 6 | 0 | | 0 | 0 | 0 | 0 | 0 |
| G | | 0 | | 0 | | G | | 0 | | 0 | |
| | 0 | 0 | 0 | | | | 0 | 0 | 0 | 4 | 0 |
| T | | 0 | | 0 | | C | | 0 | | 0 | |
| | 0 | 0 | 0 | 0 | 0 | | 0 | 10 | 0 | 6 | 0 |
| A | | 0 | | 0 | | A | | 0 | | 0 | |
| | 0 | 1 | 0 | 0 | 0 | | 0 | 1 | 0 | 0 | 0 |
| G | | 0 | | 0 | | A | | 0 | | 0 | |
| | 0 | 0 | 0 | | | | 0 | 1 | 0 | 0 | 0 |
| G | | 0 | | 0 | | G | | 0 | | 0 | |
| | 0 | 0 | 0 | 4 | 0 | | 0 | 0 | 0 | | |
| A | | 0 | | 0 | | G | | 0 | | 0 | |
| | 0 | 1 | 0 | 0 | 0 | | 0 | 0 | 0 | | |
| T | | 0 | | 0 | | T | | 0 | | 0 | |
| | 0 | 0 | 0 | | | | 0 | 0 | 0 | | |

Continue the calculation of H for the next vector “GGT” of the “G” column. From the pre-computed scoring profile, add the third weight vector for “G to the previous <H> vector from the “C” column. Steps 3-7 from above will be repeated with the new values.

(1) <4, 4, 0>+<10, 1, 1>=<14, 5, 1>

(2) Max(<0, 0, 0>, <14, 5, 1>)=<14, 5, 1>

(3) Max(<0, 0, 0>, <14, 5, 1>)=<14, 5, 1>

(4) <14, 5, 1>−<10, 10, 10>=<4, 0, 0>

(5) <0, 0, 0>−<2, 2, 2>=<0, 0, 0>

(6) Max(<0, 0, 0>, <4, 0, 0>)=<4, 0, 0>

(7) <0, 0, 0>−<2, 2, 2>=<0, 0, 0>

(8) Max(<0, 0, 0>, <4, 0, 0>)=<4, 0, 0>

Performing the steps above generates Table 13 below.

TABLE 13

| | C | | G | | T | | C | | G | | T |
|---|---|---|---|---|---|---|---|---|---|---|---|
| C | | 0 | | 0 | | C | | 0 | | 0 | |
| | 0 | 10 | 0 | 0 | 0 | | 0 | 10 | 0 | 0 | 0 |
| C | | 0 | | 0 | | T | | 0 | | 0 | |
| | 0 | 10 | 0 | 6 | 0 | | 0 | 0 | 0 | 0 | 0 |
| G | | 0 | | 0 | | G | | 0 | | 0 | |
| | 0 | 0 | 0 | 14 | 4 | | 0 | 0 | 0 | 4 | 0 |
| T | | 0 | | 4 | | C | | 0 | | 0 | |
| | 0 | 0 | 0 | 0 | 0 | | 0 | 10 | 0 | 6 | 0 |
| A | | 0 | | 0 | | A | | 0 | | 0 | |
| | 0 | 1 | 0 | 0 | 0 | | 0 | 1 | 0 | 0 | 0 |
| G | | 0 | | 0 | | A | | 0 | | 0 | |
| | 0 | 0 | 0 | 5 | 0 | | 0 | 1 | 0 | 0 | 0 |
| G | | 0 | | 0 | | G | | 0 | | 0 | |
| | 0 | 0 | 0 | 4 | 0 | | 0 | 0 | 0 | 14 | 4 |
| A | | 0 | | 0 | | G | | 0 | | 0 | |
| | 0 | 1 | 0 | 0 | 0 | | 0 | 0 | 0 | 5 | 0 |
| T | | 0 | | 0 | | T | | 0 | | 0 | |
| | 0 | 0 | 0 | 1 | 0 | | 0 | 0 | 0 | 1 | 0 |

Now that all the column calculations are done, a check will be done to see if any errors were introduced by the initial F values being zero. Shift the last F vector to the right by one element.

(9) Shift(<4, 0, 0>, 1)=<0, 4, 0>

Check if any elements in <F> are greater than the first <H> vector minus Gᵢₙᵢₜ.

(10) <0, 0, 4>−<10, 10, 10>=<0, 0, 0>

(11) Cmp_gt(<0, 4, 0>, <0, 0, 0>)=TRUE

Since there is an element in <F> greater than <H> a loop is run, correcting any errors.

Set the first <H> to the maximum value of the new <F> and the old <H>.

(12) Max(<0, 4, 0>, <0, 0, 4>)=<0, 4, 4>

Calculate the F values for the next row down.

(13) <0, 4, 0>−<2, 2, 2>=<0, 2, 0>

Check if any elements in <F> are greater than the next <H> vector minus Gᵢₙᵢₜ.

(10) <6, 0, 0>−<10, 10, 10>=<0, 0, 0>

(11) Cmp_gt(<0, 2, 0>, <0, 0, 0>)=TRUE

Since there is an element in <F> greater than <H> continue the error correction on the next row down.

(12) Max(<0, 2, 0>, <6, 0, 0>)=<6, 2, 0>

(13) <0, 2, 0>−<2, 2, 2>=<0, 0, 0>

(10) <14, 5, 1>−<10, 10, 10>=<4, 0, 0>

(11) Cmp_gt(<0, 0, 0>, <4, 0, 0>)=FALSE

Since there are no more elements in <F> that are greater than <H>, start the calculations for the next column over. Performing the steps above generates Table 14 below.

TABLE 14

| | C | | G | | T | | C | | G | | T |
|---|---|---|---|---|---|---|---|---|---|---|---|
| C | | 0 | | 0 | | C | | 0 | | 0 | |
| | 0 | 10 | 0 | 0 | 0 | | 0 | 10 | 0 | 0 | 0 |
| C | | 0 | | 0 | | T | | 0 | | 4 | |
| | 0 | 10 | 0 | 6 | 0 | | 0 | 0 | 0 | 4 | 0 |
| G | | 0 | | 0 | | G | | 0 | | 0 | |
| | 0 | 0 | 0 | 14 | 4 | | 0 | 0 | 0 | 4 | 0 |
| T | | 0 | | 4 | | C | | 0 | | 0 | |
| | 0 | 0 | 0 | 4 | 0 | | 0 | 10 | 0 | 6 | 0 |
| A | | 0 | | 2 | | A | | 0 | | 2 | |
| | 0 | 1 | 0 | 2 | 0 | | 0 | 1 | 0 | 2 | 0 |
| G | | 0 | | 0 | | A | | 0 | | 0 | |
| | 0 | 0 | 0 | 5 | 0 | | 0 | 1 | 0 | 0 | 0 |
| G | | 0 | | 0 | | G | | 0 | | 0 | |
| | 0 | 0 | 0 | 4 | 0 | | 0 | 0 | 0 | 14 | 4 |
| A | | 0 | | 0 | | G | | 0 | | 0 | |
| | 0 | 1 | 0 | 0 | 0 | | 0 | 0 | 0 | 5 | 0 |
| T | | 0 | | 0 | | T | | 0 | | 0 | |
| | 0 | 0 | 0 | 1 | 0 | | 0 | 0 | 0 | 1 | 0 |

Now continue to Smith-Waterman calculations on the next column “T”.

Initialize the F vector to zero. The initial F vector is processing the first values from each segment, i.e. <F>={q₁, q₄, q₇}.

Calculate the H value for the first vector of the “T” column. From the pre-computed scoring profile, add the first weight vector for “T” to <H>. To calculate H the weight is added to the H value that is to the left and up one cell.

Shift(<14, 5, 1>, 1)=<0, 14, 5>

Add the weight to the H vector.

(1) <−6, 6, 0>+<0, 14, 5>=<0, 20, 5>

Set H to the maximum value of E and H.

(2) Max(<0, 0, 0>, <0, 20, 5>)=<0, 20, 5>

Set H to the maximum value of F and H.

(3) Max(<0, 0, 0>, <0, 20, 5>)=<0, 20, 5>

Calculate the new H score is starting a new gap.

(4) <0, 20, 5>−<10, 10, 10>=<0, 10, 0>

Calculate the E values for the next column over.

(5) <0, 0, 0>−<2, 2, 2>=<0, 0, 0>

(6) Max(<0, 0, 0>, <0, 10, 0>)=<0, 10, 0>

Calculate the F values for the next column over.

(7) <0, 0, 0>−<2, 2, 2>=<0, 0, 0>

(8) Max(<0, 0, 0>, <0, 10, 0>)=<0, 10, 0>

Performing the steps above generates Table 15 below.

TABLE 15

| | C | | G | | T | | | C | | G | | T | |
|---|---|---|---|---|---|---|---|---|---|---|---|---|---|
| C | | 0 | | 0 | | 0 | C | | 0 | | 0 | | 0 |
| | 0 | 10 | 0 | 0 | 0 | 0 | | 0 | 10 | 0 | 0 | 0 | 0 |
| C | | 0 | | 0 | | 0 | T | | 0 | | 4 | | 0 |
| | 0 | 10 | 0 | 6 | 0 | | | 0 | 0 | 0 | 4 | 0 | 20 |
| G | | 0 | | 0 | | | G | | 0 | | 0 | | 0 |
| | 0 | 0 | 0 | 14 | 4 | | | 0 | 0 | 0 | 4 | 0 | 5 |
| T | | 0 | | 4 | | 0 | C | | 0 | | 0 | | 0 |
| | 0 | 0 | 0 | 4 | 0 | 20 | | 0 | 10 | 0 | 6 | 0 | |
| A | | 0 | | 2 | | 10 | A | | 0 | | 2 | | 10 |
| | 0 | 1 | 0 | 2 | 0 | | | 0 | 1 | 0 | 2 | 0 | |
| G | | 0 | | 0 | | | A | | 0 | | 0 | | 0 |
| | 0 | 0 | 0 | 5 | 0 | | | 0 | 1 | 0 | 0 | 0 | |
| G | | 0 | | 0 | | 0 | G | | 0 | | 0 | | |
| | 0 | 0 | 0 | 4 | 0 | 5 | | 0 | 0 | 0 | 14 | 4 | |
| A | | 0 | | 0 | | 0 | G | | 0 | | 0 | | |
| | 0 | 1 | 0 | 0 | 0 | | | 0 | 0 | 0 | 5 | 0 | |
| T | | 0 | | 0 | | | T | | 0 | | 0 | | |
| | 0 | 0 | 0 | 1 | 0 | | | 0 | 0 | 0 | 1 | 0 | |

Continue the calculation of H for the next vector “CAA” of the “T” column. Steps 1-8 from above will be repeated with the new values.

(1) <−6, −2, −2>+<0, 4, 4>=<0, 2, 2>

(2) Max(<0, 0, 0>, <0, 2, 2>)=<0, 2, 2>

(3) Max(<0, 10, 0>, <0, 2, 2>)=<0, 10, 2>

(4) <0, 10, 2>−<10, 10, 10>=<0, 0, 0>

(5) <0, 0, 0>−<2, 2, 2>=<0, 0, 0>

(6) Max(<0, 0, 0>, <0, 0, 0>)=<0, 0, 0>

(7) <0, 10, 0>−<2, 2, 2>=<0, 8, 0>

(8) Max(<0, 8, 0>, <0, 0, 0>)=<0, 8, 0>

Continue the calculation of H for the next vector “GGT” of the “T” column. Steps 1-8 from above will be repeated with the new values.

(1) <0, 0, 6>+<6, 2, 0>=<6, 2, 6>

(2) Max(<4, 0, 0>, <6, 2, 6>)=<6, 2, 6>

(3) Max(<0, 8, 0>, <6, 2, 6>)=<6, 8, 6>

(4) <6, 8, 6>−<10, 10, 10>=<0, 0, 0>

(5) <4, 0, 0>−<2, 2, 2>=<2, 0, 0>

(6) Max(<2, 0, 0>, <0, 0, 0>)=<2, 0, 0>

(7) <0, 8, 0>−<2, 2, 2>=<0, 6, 0>

(8) Max(<0, 6, 0>, <0, 0, 0>)=<0, 6, 0>

Performing the steps above generates Table 16 below.

TABLE 16

| | C | | G | | T | | | C | | G | | T | |
|---|---|---|---|---|---|---|---|---|---|---|---|---|---|
| C | | 0 | | 0 | | 0 | C | | 0 | | 0 | | 0 |
| | 0 | 10 | 0 | 0 | 0 | 0 | | 0 | 10 | 0 | 0 | 0 | 0 |
| C | | 0 | | 0 | | 0 | T | | 0 | | 4 | | 0 |
| | 0 | 10 | 0 | 6 | 0 | 0 | | 0 | 0 | 0 | 4 | 0 | 20 |
| G | | 0 | | 0 | | 0 | G | | 0 | | 0 | | 0 |
| | 0 | 0 | 0 | 14 | 4 | 6 | | 0 | 0 | 0 | 4 | 0 | 5 |
| T | | 0 | | 4 | | 0 | C | | 0 | | 0 | | 0 |
| | 0 | 0 | 0 | 4 | 0 | 20 | | 0 | 10 | 0 | 6 | 0 | 0 |
| A | | 0 | | 2 | | 10 | A | | 0 | | 2 | | 10 |
| | 0 | 1 | 0 | 2 | 0 | 10 | | 0 | 1 | 0 | 2 | 0 | 10 |
| G | | 0 | | 0 | | 8 | A | | 0 | | 0 | | 0 |
| | 0 | 0 | 0 | 5 | 0 | 8 | | 0 | 1 | 0 | 0 | 0 | 2 |
| G | | 0 | | 0 | | 0 | G | | 0 | | 0 | | 0 |
| | 0 | 0 | 0 | 4 | 0 | 5 | | 0 | 0 | 0 | 14 | 4 | 6 |
| A | | 0 | | 0 | | 0 | G | | 0 | | 0 | | 8 |
| | 0 | 1 | 0 | 0 | 0 | 2 | | 0 | 0 | 0 | 5 | 0 | 8 |
| T | | 0 | | 0 | | 0 | T | | 0 | | 0 | | 0 |
| | 0 | 0 | 0 | 1 | 0 | 6 | | 0 | 0 | 0 | 1 | 0 | 6 |

Now that all the column calculations are done, a check will be done to see if any errors were introduced by the initial F values being zero.

Shift the last F vector to the right by one element.

(9) Shift(<0, 6, 0>, 1)=<0, 0, 6>

Check if any elements in <F> are greater than the first <H> vector minus Gᵢₙᵢₜ. Step from above.

(10) <0, 20, 5>−<10, 10, 10>=<0, 10, 0>

(11) Cmp_gt(<0, 0, 6>, <0, 10, 0>)=TRUE

Since there is an element in <F> greater than <H> a loop is run, correcting any errors.

Set the first <H> to the maximum value of the new <F> and the old <H>.

(12) Max(<0, 0, 6>, <0, 20, 5>)=<0, 20, 6>

Calculate the F values for the next row down.

(13) <0, 0, 6>−<2, 2, 2>=<0, 0, 4>

Check if any elements in <F> are greater than the next <H> vector minus Gᵢₙᵢₜ.

(10) <0, 10, 2>−<10, 10, 10>=<0, 0, 0>

(11) Cmp_gt(<0, 0, 4>, <0, 0, 0>)=TRUE

Performing the steps above generates Table 17 below.

TABLE 17

| | C | | G | | T | | | C | | G | | T | |
|---|---|---|---|---|---|---|---|---|---|---|---|---|---|
| C | | 0 | | 0 | | 0 | C | | 0 | | 0 | | 0 |
| | 0 | 10 | 0 | 0 | 0 | 0 | | 0 | 10 | 0 | 0 | 0 | 0 |
| C | | 0 | | 0 | | 0 | T | | 0 | | 4 | | 0 |
| | 0 | 10 | 0 | 6 | 0 | 0 | | 0 | 0 | 0 | 4 | 0 | 20 |
| G | | 0 | | 0 | | 0 | G | | 0 | | 0 | | 6 |
| | 0 | 0 | 0 | 14 | 4 | 6 | | 0 | 0 | 0 | 4 | 0 | 6 |
| T | | 0 | | 4 | | 0 | C | | 0 | | 0 | | 0 |
| | 0 | 0 | 0 | 4 | 0 | 20 | | 0 | 10 | 0 | 6 | 0 | 0 |
| A | | 0 | | 2 | | 10 | A | | 0 | | 2 | | 10 |
| | 0 | 1 | 0 | 2 | 0 | 10 | | 0 | 1 | 0 | 2 | 0 | 10 |
| G | | 0 | | 0 | | 8 | A | | 0 | | 0 | | 4 |
| | 0 | 0 | 0 | 5 | 0 | 8 | | 0 | 1 | 0 | 0 | 0 | 2 |
| G | | 0 | | 0 | | 0 | G | | 0 | | 0 | | 0 |
| | 0 | 0 | 0 | 4 | 0 | 5 | | 0 | 0 | 0 | 14 | 4 | 6 |
| A | | 0 | | 0 | | 0 | G | | 0 | | 0 | | 8 |
| | 0 | 1 | 0 | 0 | 0 | 2 | | 0 | 0 | 0 | 5 | 0 | 8 |
| T | | 0 | | 0 | | 0 | T | | 0 | | 0 | | 0 |
| | 0 | 0 | 0 | 1 | 0 | 6 | | 0 | 0 | 0 | 1 | 0 | 6 |

Since there is an element in <F> greater than <H> continue the error correction on the next row down. Repeat steps from above.

(12) Max(<0, 0, 4>, <0, 10, 2>)=<0, 10, 4>

(13) <0, 0, 4>−<2, 2, 2>=<0, 0, 2>

(10) <6, 8, 6>−<10, 10, 10>=<0, 0, 0>

(11) Cmp_gt(<0, 0, 2>, <0, 0, 0>)=TRUE

Since there is an element in <F> greater than <H> continue the error correction on the next row down. Repeat steps from above.

(12) Max(<0, 0, 2>, <6, 8, 6>)=<6, 8, 6>

(13) <0, 0, 2>−<2, 2, 2>=<0, 0, 0>

Performing the steps above generates Table 18 below.

TABLE 18

| | C | | G | | T | | | C | | G | | T | |
|---|---|---|---|---|---|---|---|---|---|---|---|---|---|
| C | | 0 | | 0 | | 0 | C | | 0 | | 0 | | 0 |
| | 0 | 10 | 0 | 0 | 0 | 0 | | 0 | 10 | 0 | 0 | 0 | 0 |
| C | | 0 | | 0 | | 0 | T | | 0 | | 4 | | 0 |
| | 0 | 10 | 0 | 6 | 0 | 0 | | 0 | 0 | 0 | 4 | 0 | 20 |
| G | | 0 | | 0 | | 0 | G | | 0 | | 0 | | 6 |
| | 0 | 0 | 0 | 14 | 4 | 6 | | 0 | 0 | 0 | 4 | 0 | 6 |
| T | | 0 | | 4 | | 0 | C | | 0 | | 0 | | 0 |
| | 0 | 0 | 0 | 4 | 0 | 20 | | 0 | 10 | 0 | 6 | 0 | 0 |
| A | | 0 | | 2 | | 10 | A | | 0 | | 2 | | 10 |
| | 0 | 1 | 0 | 2 | 0 | 10 | | 0 | 1 | 0 | 2 | 0 | 10 |
| G | | 0 | | 0 | | 8 | A | | 0 | | 0 | | 4 |
| | 0 | 0 | 0 | 5 | 0 | 8 | | 0 | 1 | 0 | 0 | 0 | 4 |
| G | | 0 | | 0 | | 6 | G | | 0 | | 0 | | 0 |
| | 0 | 0 | 0 | 4 | 0 | 6 | | 0 | 0 | 0 | 14 | 4 | 6 |
| A | | 0 | | 0 | | 4 | G | | 0 | | 0 | | 8 |
| | 0 | 1 | 0 | 0 | 0 | 4 | | 0 | 0 | 0 | 5 | 0 | 8 |
| T | | 0 | | 0 | | 2 | T | | 0 | | 0 | | 2 |
| | 0 | 0 | 0 | 1 | 0 | 6 | | 0 | 0 | 0 | 1 | 0 | 6 |

As described herein, the algorithm typically used to find the optimal local alignment is the Smith-Waterman. With conditional code, the execution time is generally dependent on the length of the query string and the database, the scoring matrix and gap penalties. To speed up the algorithm, Single Instruction Multiple Data (SIMD) instructions have been used to parallelize the algorithm at the instruction level.

One embodiment of the present invention is a new Smith-Waterman implementation where the SIMD registers are parallel to the query sequence, but are accessed in a striped pattern. Similar to the Rognes implementation, the query profile is calculated once for the data base search, but the conditional F calculations are moved outside the inner loop.

Referring again to the current Smith-Waterman, with the Gotoh (1982) improvements, this algorithm is typically used to compute the optimal local alignment for handling multiple sized gap penalties. For two sequences to be compared, the query sequence and the database sequence, are defined as Q=q₁, q₂ . . . qₘ and D=d₁, d₂ . . . dₙ. The length of the query sequence and database sequence are m=|Q| and n=|D|, respectively. A scoring matrix W(qᵢ, dⱼ) is defined for all residue pairs. Usually the weight W(qᵢ, dⱼ)≦0 when q_{i—}=dⱼ and W(qᵢ, dⱼ)>0 when qᵢ=dⱼ. The penalty for starting a gap and continuing a gap are defined as Gᵢₙᵢₜ and Gₑₓₜ, respectively. The alignment scores ending with a gap along D and Q are E Equation (1) and F Equation (2), respectively.

$$\begin{matrix}{E}_{i , j} = max \text{?} \\ \text{?} \text{indicates text missing or illegible when filed} & ( 1 ) \\ {F}_{i , j} = max \text{?} \\ \text{?} \text{indicates text missing or illegible when filed} & ( 2 )\end{matrix}$$

The alignment score for H_{i,j} where 1≦i≦m and 1≦j≦n is defined by the Equation (3).

$${H}_{i , j} = max \{ \begin{matrix}0 , \\ {E}_{i , j} , \\ {F}_{i , j} , \\ \text{?}\end{matrix} \} \\ \text{?} \text{indicates text missing or illegible when filed} \qquad ( 3 )$$

The values for H_{i,j}, E_{i,j} and F_{i,j} are equal to 0 when i<1 or j<1.

When calculating H_{i,j} the value from the scoring matrix W(qᵢ, dⱼ) is added to H_{i-1, j-1}. To avoid the lookup of W(qᵢ, dⱼ) for each cell, Rognes and Seeberg calculated a query profile parallel to the query for each possible residue. The query profile in this implementation is calculated just once for each database search. Then the calculation of H_{i,j} requires just an addition of the pre-calculated score to the previous H_{i,j}.

According to one embodiment of the present invention, the vectors in both the Rognes implementation and the present implementation run parallel to the query sequence, but the present Smith-Waterman implementation accesses the query in a striped pattern unlike the sequential access performed by Rognes.

Referring again to the Striped Smith-Waterman implementation of FIG. 3, the memory layout for the query profile is similar to the Rognes implementation of FIG. 2a, wherein the vectors in both implementations run parallel to the query sequence, but the striped implementation in this embodiment of the present invention reorders the query in a striped pattern unlike the sequential access for Rognes.

By way of illustration, the vectors are arranged in computer memory in a linear fashion, and the system uses straight memory which makes it efficient as most modern hardware pre-fetches. The striped pattern is made up of several components, namely the length of the query sequence divided by an equal number of partitions, wherein the number of partitions is equal to the number of elements being processed in the vector register. The n^{th} vector register processes the n^{th} values from each of the partitions. No other system performs reordering as defined herein. Certain state of the art implementations perform processing in a diagonal fashion but without reordering. Another prior implementation uses an instruction set to reorder the position-specific scoring matrices (PSSM) data using several instructions to get the data's order to match the query string order, and it performs this processing for every single database vector. In contrast, the embodiment herein performs the reordering once outside the loop.

The striped Smith-Waterman implementation takes a similar approach by pre-calculating the query profile, but with a different layout than Rognes. The layout used by the query profile is a striped access parallel to the query sequence.

In more particular detail, the query is divided into equal length segments, S. The number of segments, p, is equal to the number of elements being processed in the SIMD register. When processing byte integers (8 bit values) p=16 and when processing word integers (16 bit values) p=8. The length of each segment t is (|Q|+p−1)/p. If the query is not long enough to fill all the segments, t>|Q|, the segments are padded with null entries that have a weight of zero. The query segments are defined as Sₙ=qₜ₍ₙ₋₁₎₊₁, qₜ₍ₙ₋₁₎₊₂, . . . , qₜ₍ₙ₋₁₎₊ₜ where 1≦n≦p. Each element of the SIMD registers maps to one segment. The first element in the vector maps to S₁, the second element in the vector maps to S₂, till the last element in the vector maps to Sₚ. The vectors move uniformly across the segments, so <H_{i,j}> processes the i^{th} element of all the segments. Equation (4) shows the segment layout when p=8 and the elements processed by the SIMD register when i=2.

$$\begin{matrix}{S}_{1} = & {q}_{1} \\ {S}_{2} = & {q}_{t + 1} \\ {S}_{3} = & {q}_{2 t + 1} \\ {S}_{4} = & {q}_{3 t + 1} \\ {S}_{5} = & {q}_{4 t + 1} \\ {S}_{6} = & {q}_{5 t + 1} \\ {S}_{7} = & {q}_{6 t + 1}\end{matrix} \begin{matrix}{q}_{2} \\ {q}_{t + 2} \\ {q}_{2 t + 2} \\ {q}_{3 t + 2} \\ {q}_{4 t + 2} \\ {q}_{5 t + 2} \\ {q}_{6 t + 2}\end{matrix} \begin{matrix}{q}_{3} & ⋯ & {q}_{t} \\ {q}_{t + 3} & ⋯ & {q}_{2 t} \\ {q}_{2 t + 3} & ⋯ & {q}_{3 t} \\ {q}_{3 t + 3} & ⋯ & {q}_{4 t} \\ {q}_{4 t + 3} & ⋯ & {q}_{5 t} \\ {q}_{5 t + 3} & ⋯ & {q}_{6 t} \\ {q}_{6 t + 3} & ⋯ & {q}_{8 t}\end{matrix} \qquad ( Equation 4 )$$

The vectors making up the scoring profile W, like the H vectors, also moves uniformly across the segments. The layout of the scoring profile, when p=8, is:

$$\text{?}$$

$$\text{?} \text{indicates text missing or illegible when filed}$$

The pseudo code referenced below shows an example for generating the query profile for SIMD registers processing 16 elements. The query profile is stored in memory on 16-byte boundaries. By aligning the profile on a 16-byte boundary, the values are read with a single aligned load instruction which is faster than reading unaligned data.

Pseudocode Sample A

```
// Calculate the length of the segments so that the
// query fits evenly in the different segments.
segLen := (length (Q) + 15) / 16;
// Build the query profile for all possible residues
foreach a in AminoAcids
  h := 0;
  for i := 0 ... segLen
    j := i;
    for k := 1 ... 16
      if (j > length (Q))
        // We are beyond the length of the query
        // string so pad the weights with neutral
        // scores.
        queryProfile[a][h] := 0;
      else
        // Set the score to the weight in the scoring
        // matrix.
        queryProfile[a][h] := W(a,q[j]);
      endif
      h := h + 1;
      j := j + segLen;
    endfor
  endfor
endfor
```

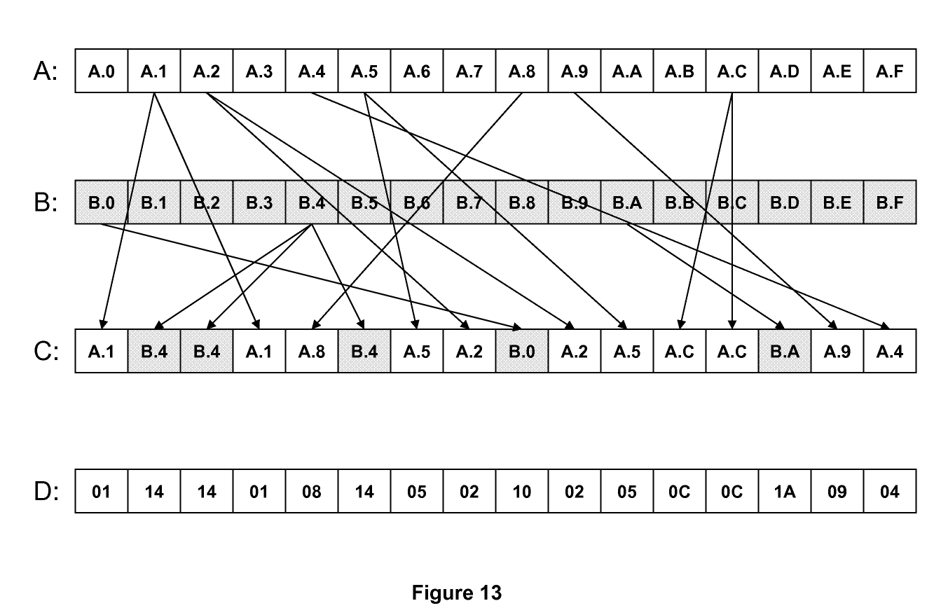

Referring to FIG. 13, a space saving alternative to generating the query profile is to build a shuffle vector P, based on the query string. Many SIMD processors have a shuffle or permute instruction which allows the program to reorder data from one or more registers into a source register in a single instruction as shown in FIG. 13. The shuffle vector is the query string reorder to match the layout of the scoring profile. Then all amino acids are replaced with a shuffle mask corresponding to that amino acids position in the substitution matrix. Here, the bytes selected for the shuffle from the source registers, A and B, are based on byte entries in the control register D, in which a 0 specifies register A and a 1 specifies register B. The result of the shuffle is placed in register C.

As noted in FIG. 1b and FIG. 2b, both the Wozniak and Rognes/Seeberg implementations have data dependencies between the previous H vector and the current H vector. This is also true when calculating F. Before H or F is calculated, the last element in the previous vector is moved to the first element in the current vector.

However, by using the striped query access according to one embodiment of the present invention, these data dependencies are moved out of the inner loop and done just once in the outer loop when processing the next database residue.

The striped Smith-Waterman SIMD implementation was written for Intel processors supporting SSE2 instructions. The pseudo code for the implementation is shown below. The code was written in C using Intel's SSE2 intrinsic functions for portability.

Pseudocode Sample B

```
// Calculate the number of iterations needed to
// process the query string. This calculation assumes
// there are 16 elements in the SIMD register.
segLen := (length (Q) + 15) / 16;
// Outer loop to process the database sequence
for i := 0 ... dbLen
  // Initialize F value to zeros. Any errors to vH values
  // will be corrected in the Lazy-F loop.
  vF := <0, ..., 0>;
  // Adjust the last H value to be used in the next
  // segment over
  vH := vHStore[segLen − 1] << 1;
  // Swap the two H buffers
  swap (vHLoad, vHStore);
  // Inner loop to process the query sequence
  for j := 0 ... segLen
    // Add the scoring profile to vH
    vH := vH + vProfile[i][j];
    // Save any vH values greater than the max
    vMax := max (vMax, vH);
    // Adjust vH with any greater vE or vH values
    vH := max (vH, vE[j]);
    vH := max (vH, vF);
    // Save the vH values off
    vHStore[j] := vH;
    // Calculate the new vE and vF based on the
    // gap penalties for this search
    vH := vH − vGapopen;
    vE[j] := vE[j] − vGapExtend;
    vE[j] := max (vE[j], vH);
    vF := vF − vGapExtend;
    vF := max (vF, vH);
    // Load the next vH value to process
    vH := vHLoad[j];
  endfor
  // - - - Lazy-F Loop - - -
  // Shift the vF left so its values can be used to
  // correct the next segment over.
  vF := vF << 1;
  // Correct the vH values until there are no elements
  // in vF that could influence the vH values.
  J := 0;
  while (AnyElement (vF > vHStore[j] − vGapOpen)
    vHStore[j] := max (vHStore[j], vF);
    vF := vF − vGapExtend;
    if (++j >= segLen)
      // If we processed the entire segment, we need
      // to carry the vF values to the next segment.
      vF := vF << 1;
      j := 0;
    endif
  endwhile
endfor
```

To maximize the number of cells calculated per instruction, the SIMD SSE2 registers are divided into their smallest unit possible. The 128-bit wide registers are divided into 16 8-bit elements for processing. One instruction can therefore operate on 16 cells in parallel. Dividing the register into 8-bit elements limits the cell's range from 0-255. In most cases, the scores fit in the 8-bit range unless the sequences are long and similar. If a query's score exceeds the cells maximum, that query is recalculated using a higher precision.

For those queries that do require a higher precision, the register is divided into eight 16-bit elements. This gives each cell a possible range from 0-65,535. The obvious drawback to using 16-bit elements is now each instruction is processing half as many cells per instruction compared to using 8-bit elements.

Due to limitations in the SSE2 instruction set, unsigned byte integers are used in the 8-bit calculations. The SSE2 instruction set supports only maximum on unsigned byte integers. Since the maximum instruction is needed to compute E, F and H, unsigned bytes are used in the low precision calculations.

To use unsigned bytes, the query profile is biased to the smallest value in the scoring matrix. After W is added to H, the bias is subtracted from H. When the score is greater than 255-bias, the search is rerun with higher precision calculations. This approach was used in the Rognes and Seeberg implementation.

For the higher precision calculations signed short integers are used to speed up the inner loop. When using signed integers, the initial E, F and H values are biased by the minimum signed short integer value, a negative 32,768 instead of zero. By biasing the initial value with its minimum possible value, the complete range of the element can be used. When the search is done the bias is added back to H returning a score between 0-65,535. Using signed arithmetic, the weight is not biased, therefore the instruction subtracting bias from H is not needed in the inner loop keeping calculation times down.

The H_{i,j} calculation is dependent on the previous value on the major diagonal, H_{i-1,j-1}. To simplify the code for handling this dependency, two buffers are allocated for storing the H values. On the first pass, one buffer is used to read the previous H values and the other buffer is used to store the new H values. On the next pass, the buffers are swapped, so the input H buffer is now the output H buffer and visa-versa.

If the shuffle profile is being used in place of the query profile, the weight value <W_{i,j}> is calculated in three step. First the weight values for the current database residue are loaded from the substitution matrix. This can be done once for the entire column being calculated. Then the shuffle vector <Pᵢ> is loaded for the current <H_{i,j}> vector. The weight value <W_{i,j}> is the calculated by reordering the weight values by the shuffle vector, <Pᵢ>.

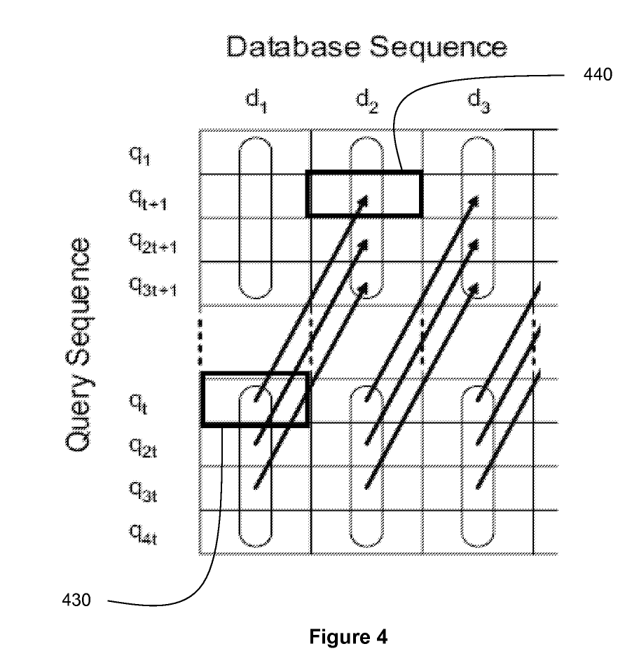

The computation of <H_{i,j}>where 1≦i≦t, is the addition of the weight <W_{i,j}> to <H_{i-1,j}>to access the H values on the major diagonal. If i=1 then <H_{t,j}> is shifted to the left by one element and added to <W_{i,j}>. FIG. 4 shows the data dependencies between the last H vector and the first H vector of the next column.

The inner loop therefore no longer requires the extra operations to insert the H value into the next SIMD register. The only shifting of H is done once in the outer loop to get <H_{t,j}> in the correct order. The data dependencies between the last H vector and the first H vector of the next column are illustrated. The values in the last H vector are shifted to the left so the values are aligned with the next segment over.

The computation of <E_{i,j}> where 1≦i≦t, is the subtraction of the gap extension penalty, Gₑₓₜ, from <E_{i,j-1}> to access the E values to the left of the current cells. If i=1 then zeros are used for the value of E. The computation of <F_{i,j}> where 1≦i≦t, is the subtraction of the gap extension penalty, Gₑₓₜ, from <F_{i-1,j}> to access the F values above the current cells. If i=1 then the initial calculation of <F_{1,j}> is dependent on <F_{t,j}> shifted to the left by one. Since the values of <F_{t,j}> are unknown until the inner loop has completed, zeros are substituted and any errors introduced are corrected in a second pass.

Lazy F evaluation. For most cells in the matrix, F remains at zero and does not contribute to the value of H. Only when H is greater than Gᵢₙᵢₜ+Gₑₓₜ will F start to influence the value of H. In many instances the second pass at correcting errors introduced by F is not necessary. Pseudo code sample B includes the processing for the secondary loop for correcting any error caused by initial F values. After the inner loop has completed <F_{t,j}> is checked against the values of <H_{1,j}> to see if the second pass is necessary. The values in <F_{t,j}> are shifted to the left by one and if any elements are greater than <H_{1,j}>−Gᵢₙᵢₜ, then H is recalculated because F can change the value of H.

The second pass loop is executed until all elements in F are less than H−Gᵢₙᵢₜ. If this loop processes all the segments without an early exit, an additional pass might be needed to recalculate F. Since each element in the vector represents a different segment of the query sequence, after processing the last vector <F_{t,j}>, the values in <F_{t,j}> are shifted to the left by one to move their values to the next segment.

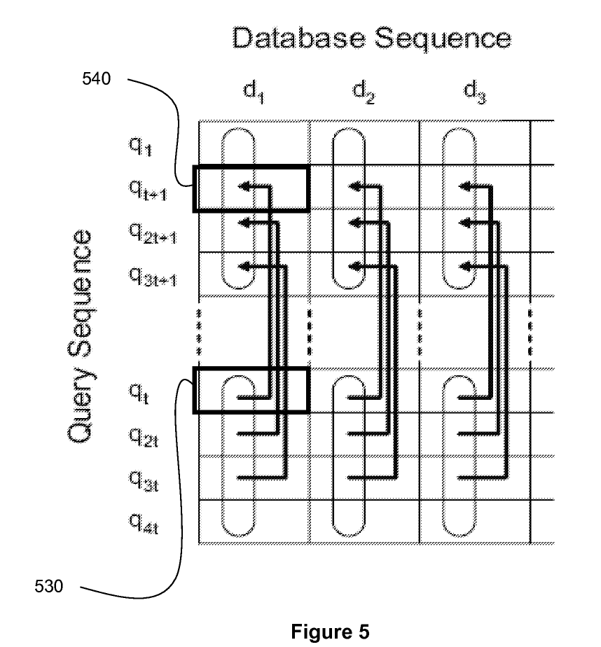

Referring to FIG. 5, the data dependencies between the last F vector and the first are shown. If any elements in <F_{t,j}> are still greater than <H_{1,j}>−Gᵢₙᵢₜ, the loop is executed again. This loop is repeated until all elements in F are below the threshold.

One advantage of this approach is all branches are moved out of the inner loop to the outer loop. Modern processors typically use branch prediction to limit the impact of branching on the run time. As execution pipelines get deeper to support higher clock rates, the penalty for a mis-prediction increases and therefore conditional branches should be eliminated if possible. For example, the execution pipeline on the Pentium 4 is documented in the Intel, Optimization Reference Manual, incorporated by reference herein.

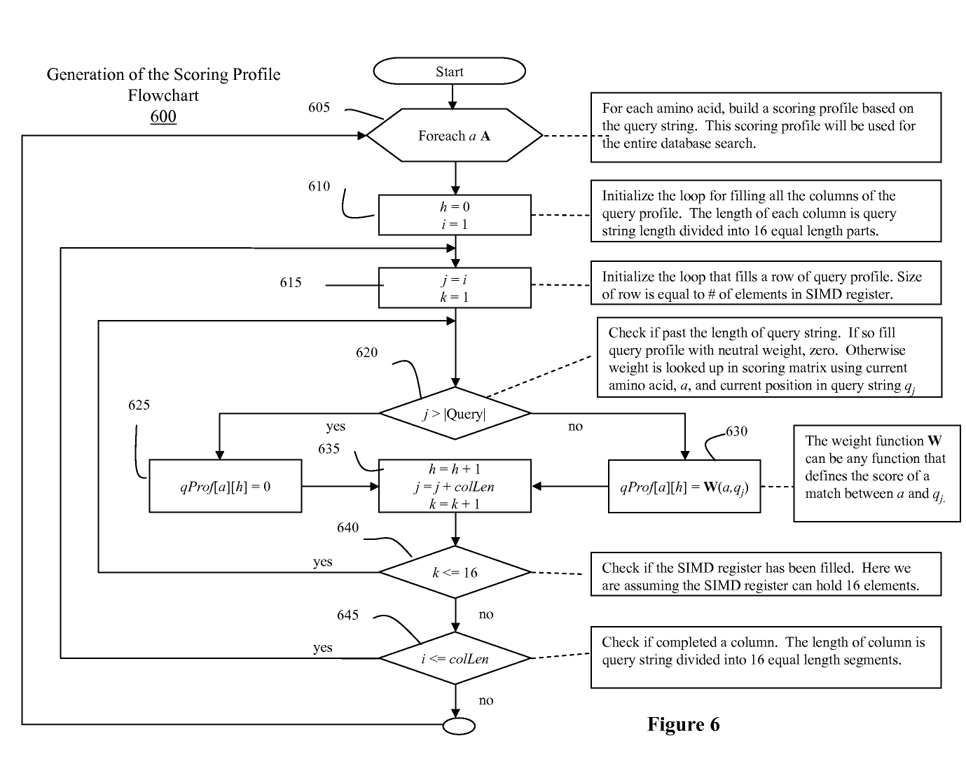

Referring to the flow chart of FIG. 6, one embodiment for generating a scoring profile is illustrated. In this flowchart, there are 16 elements in the SIMD register, however it is acknowledged that this is done for convenience and will vary depending upon the size of the element and the processor architecture.

For illustrative purposes, an amino acid example is used, wherein for each amino acid a scoring profile is built 605 based on the query string. The scoring profile is used for the entire database search. The h and i loops are initialized 610 for filling all the columns of the query profile. The length of each column is query string length divided into 16 equal length parts. The j and k loops are initialized 615 which are used to fill a row of the query profile. The size of the row is equal to the number of elements in the SIMD register.

The size of the row is checked 620 to determine if the processing is past the length of the query. If past the length of the query 625, the query profile is filled with a neutral weight, typically zero. Otherwise 630, the weight is looked up in the scoring matrix using the current amino acid, a, and current position in the query string qⱼ. The weight function W can be any function that defines the score of a match between a and qⱼ.

The variable h is incremented to the next position in the query profile, j is incremented to the index of the next query residue and k is incremented by one keeping the position within the SIMD register 635 and a check is made to determine if the SIMD register has been filled 640. In this example, it is assumed that the SIMD register holds 16 elements.

A determination is then made as to whether a column has been completed 645. The length of a column is the query string divided into 16 equal length segments. If the column is not completed, the next column is processed and the process repeats starting from initializing the loop that fills a row of the query profile 615. If the column has been completed, the processing continues for the next amino acid by building a scoring profile 605. The processing continues until all the amino acids have been profiled.

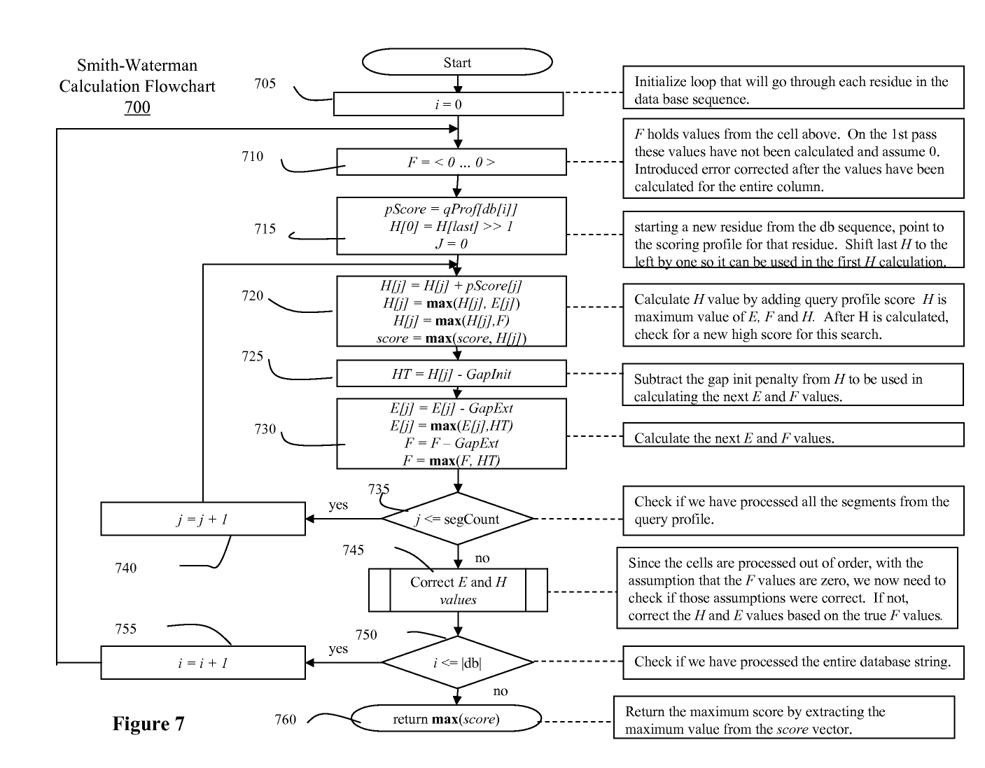

FIG. 7 illustrates a process flow for the Smith-Waterman calculation 700 according to one embodiment of the invention. The processing commences by initializing the loop that will go through each residue of the database sequence 705. The vector F hold the values from the cell above it, and on the first pass the cells are processed in order, 1, t, 2t, . . . 710. Since the values above have not yet been calculated, these values are assumed to be zero. Any error introduced by this assumption can be corrected after the values have been calculated for the entire column.

The processing commences with a new residue from the database sequence 715. A pointer to the scoring profile is designated for that residue. The last H is shifted to the left by one so that it can be used in the first H calculation. FIG. 4 shows the data dependencies between the last and first H vectors.

The H value is then calculated 720 by adding the query profile score to H. The maximum value of E, F, and H is H. After H is calculated, a check is performed to determine if there is a new high score for the search.

The gap init penalty is then subtracted from H 725, to be used in calculating the next E and F values. The next E and F values are then calculated 730.

A determination if then made as to whether all the segments have been processed from the query profile 735. If they have been processed, the j variable is incremented by 1 and the processing continues by calculating H by adding the query profile score to H 720.

If all of the segments have not been processed, the E and H values are corrected 745. Since the cells are processed out of order, with the assumption that the F values are zero, a check is commenced based on those assumptions. If the assumptions were not correct, E and H are corrected.

A check is made to determine whether the entire database string has been processed 750. If the entire database string has not been processed, variable i is incremented 755 and the processing continues with the F values 710. If the entire database string has been processed, the maximum score is returned by extracting the maximum value from the score vector 760.

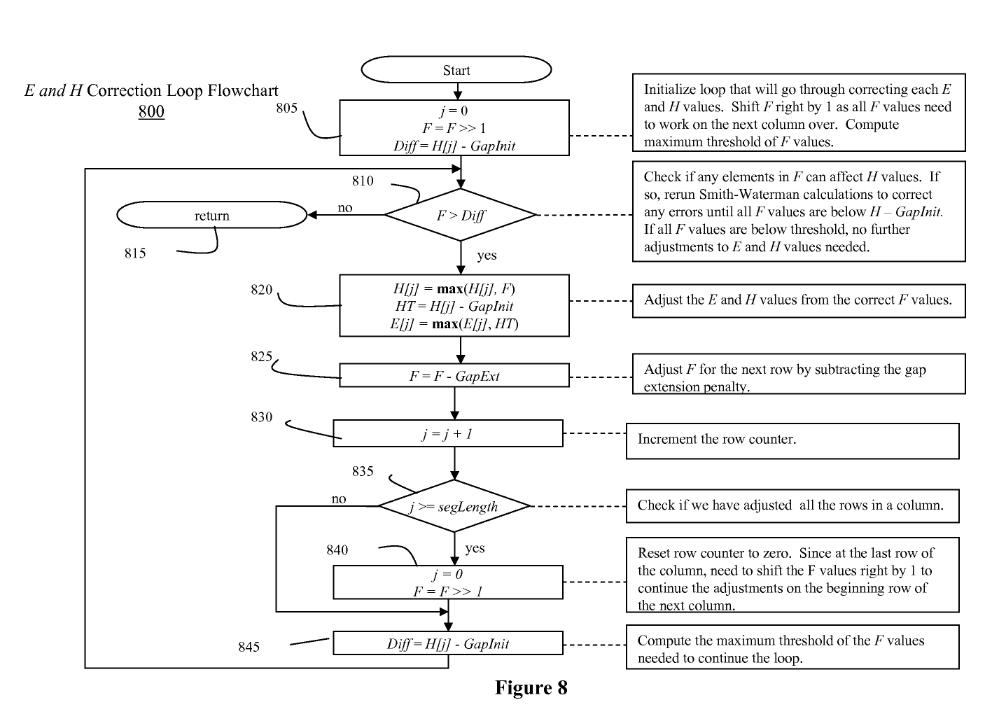

Referring to FIG. 8, the correction loop for the E and H values 800 according to one embodiment is illustrated. In distinction to the normal Smith-Waterman calculations, the cells are calculated out of order with the assumption that the F values will be zero. If any F values are greater than H−GapInit, the value in F may affect the E and H values, therefore the E and H correction loop corrects for any errors introduced by assuming that the F values are zero.

The loop that processes the E and H value corrections is initialized 805. The F value is shifted to the right by one because all the F values need to work on the next column over. FIG. 5 shows the data dependencies between the last and first F vectors. The F values are processed and the maximum threshold of the F values is computed.

A check is made to determine whether any element in F can affect the H values 810. If the F values can not affect the H values, and the F values are below the threshold, no further adjustment is needed to the E and H values and the processing returns 815.

If any of the F values are above the threshold, the Smith-Waterman calculations have to be rerun to correct any errors until all the F values are below H−GapInit. The E and H values are then adjusted from the correct F values 820.

The F values are then adjusted for the next row by subtracting the gap extension penalty 825. The row counter is then incremented 830.

A check is made to determine whether the all the rows in a column were adjusted 835. If all the rows were adjusted, the row counter is reset to zero 840, since this indicates that the last row of the column has been adjusted. The F values are shifted right by one so that the adjustments can continue on the beginning row of the next column.

The maximum threshold for the F values needed to continue the loop is then computer 845. The processing continues with checking if any of the elements in F can affect the H values 810.

An alternative to having a second loop just for correcting the H value would be to have a second loop performing the dynamic programming step while correcting the H value and calculating the cell values. If the F values cannot change the H values perform the dynamic programming steps with no code to correct the H values. If the F values can change the H values, the steps calculating H need to take this value into account.

To prevent rollovers, F values that can change more than one column, the F values are shifted to the left and a maximum is taken from the previous F value until all F values are below the threshold needed to cause a rollover.

The dynamic programming steps now have two F vectors, F for the current F value for this column and F′ for the corrected F value from the previous column. After the H vector is loaded, a new H value is calculated by taking a maximum between the current H and F′. This corrects any possible errors in H from using an assumed F values. After H is corrected, the usual dynamic programming steps are executed to calculate the H vector. Then the gap extension penalty, Gₑₓₜ, is subtracted from F′ vector. These steps are repeated for the entire query sequence.

According to one embodiment, a faster implementation of the Smith-Waterman algorithm is described herein, wherein one embodiment of the present system achieved 2-8 times performance improvement over other STMD based Smith-Waterman implementations. On a 2.0 GHz Xeon Core 2 Duo processor, speeds of >3.0 billion cell updates/s were achieved. This is a speedup of 2-8 times over the Wozniak and Rognes STMD implementations.

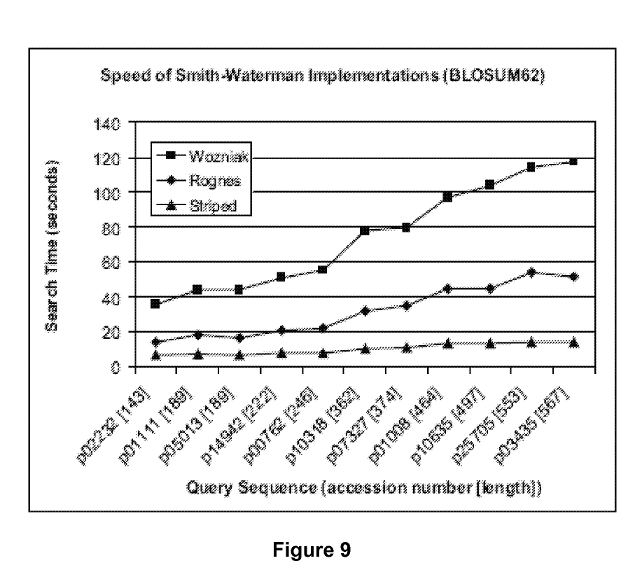

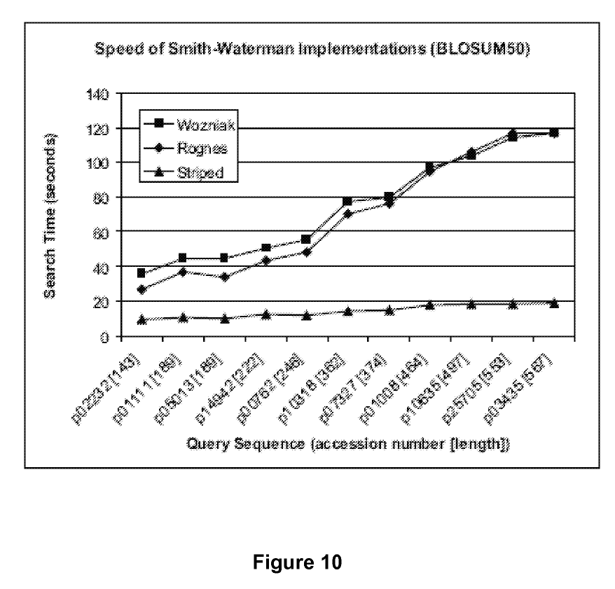

In FIG. 9, calculation times for the different Smith-Waterman implementations are shown using the BLOSUM62 scoring matrix with a gap penalty of 10-k. FIG. 10 illustrates calculation times for the different Smith-Waterman implementations using the BLOSUM50 scoring matrix with a gap penalty of 10-k.

For the first test, the scoring matrix BLOSUM62 with a gap open penalty of 10 and a gap extension penalty of 1 were used. The same scoring matrix and gap penalties were used to evaluate BLAST2 and SWMMX. The search times for each of the 11 query sequences are shown in FIG. 9. The Wozniak implementation completed the search in 821 seconds with an average of 352 MCUPS and a peak of 367 MCUPS. The Rognes implementation turns in a better search time of 354 seconds with an average of 816 MCUPS and a peak of 865 MCUPS. Finally, the striped implementation completed the search in 113 seconds with an average of 2,553 MCUPS and a peak of 2,998 MCUPS. The next test used the same gap penalty, 10-k, but utilized the BLOSUM50 scoring matrix. The results are shown in FIG. 10. With the higher H scores, more time was spent calculating the value of F. The Wozniak implementation stayed the same taking a total of 821.

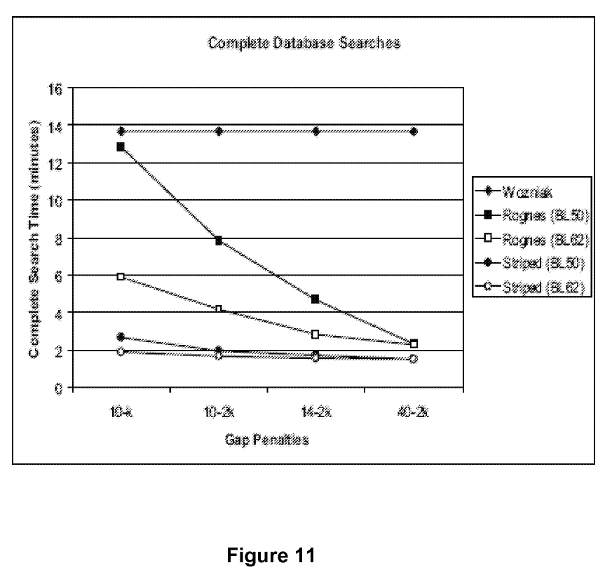

Referring to FIG. 11, total calculation times for the different Smith-Waterman implementations using BLOSUM50 and BLOSUM62 with gap penalties of 10-k, 10-2 k, 14-2 k and 40-2 k seconds still averaging 351 MCUPS with a peak of 367 MCUPS. The Rognes implementation turned in a slightly better time of 771 seconds with the average MCUPS dropping to 374 with a peak of 419 MCUPS. The striped implementation was also affected by the higher H values taking 159 seconds to run the search averaging 1,817 MCUPS with a peak of 2,256 MCUPS. The third test used the same 11 query sequences with the BLOSUM50 and BLOSUM62 scoring matrices, but with four different gap penalties, 10-k, 10-2 k, 14-2 k and 40-2 k. The total search times for all of the 11 query sequences are shown in FIG. 9. With a large gap penalty of 40-2 k, most of the F calculations were skipped for the Rognes and striped implementations, basically testing just the efficiency of the inner loop. The Wozniak implementation total search time was 13.68 minutes. The search times for the Rognes implementation using the gap penalty of 40-2 k, took 2.31 minutes for both scoring matrices, a 60%-80% improvement over the 10-k times. The striped implementation using the gap penalty of 40-2 k took 1.51 minutes, only a 20%-40% improvement over the 10-k times.

The final comparison is against heuristic programs FASTA 34t26b4 (Pearson et al., 1988) and NCBI BLAST 2.2.14 (Altschul et al., 1997). The executables used in testing were downloaded from their respective web sites, the University of Virginia and the NCBI. For a more meaningful comparison, SSEARCH was modified to use the striped Smith-Waterman implementation. All the searches were run using the BLOSUM50 scoring matrix and gap penalties of 10-2 k. The options for all programs were to display the top 500 scores with no alignments. The search times for the 11 query sequences are shown in FIG. 10. FASTA was run with both ktup=1 and ktup=2. On the whole, the striped Smith-Waterman was faster than FASTA, more than 50% faster when ktup=2 and four time faster when ktup=1. SSEARCH averaged about 30% slower runtimes when compared to BLAST.

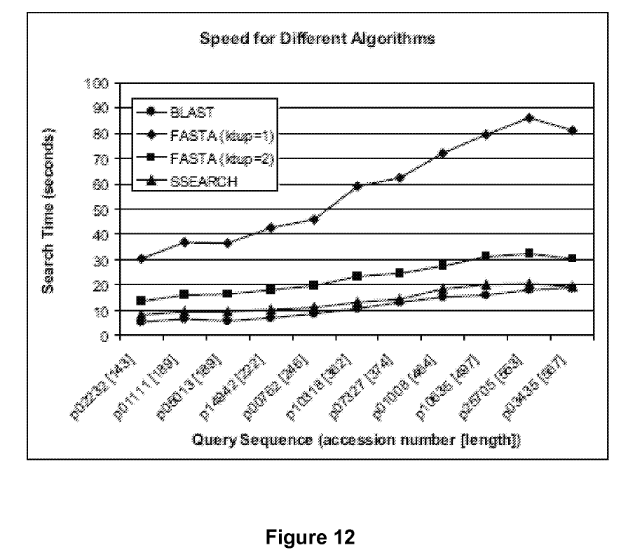

FIG. 12 illustrates search times for different programs using heuristic algorithms and SSEARCH using the striped Smith-Waterman implementation. The searches were run using the BLOSUM50 scoring matrix with a gap penalty of 10-2 k. The efficacy of the operation of the SSEARCH using the striped Smith-Waterman implementation is visually depicted.

Due to the number of iterations in the Smith-Waterman calculations, reducing the number of instructions in the inner loop had a significant effect on the execution time. By using pre-calculated weights, removing the SIMD register data dependencies and moving all branches out of the inner loop, the striped Smith-Waterman has a very efficient inner loop. Thus one embodiment is an efficient SIMD implementation of the dynamic programming algorithm that is adaptable to other biological problems.

According to one embodiment, after the processing is completed, a set of results, such as high scores, are reported for interpretation and/or alignment. The results can be communicated to a user or another program for further processing. For example, algorithm detailed herein can process a very large database wherein and it reports back sequence and corresponding scores to build a refined database of the highest scores for alignment or further statistical analysis. Thus, the present invention can be used to eliminate or reduce meaningless scores. In another embodiment the location of the highest scores was also reported to enhance alignment.

According to one embodiment the processing includes initializing elements, loading weights, adding weights to prior values, taking maximums and repeating the steps. The next step checks whether the initial values were correct and making corrections. The dynamic programming includes mathematical processing using algorithms such as Smith-Waterman, Viterbi, Needleman-Wunsch, and Gotoh.

One implementation uses block substitution matrices as the scoring matrix. The implementation could easily be adapted to use other types of scoring functions, such as position-specific scoring matrices (PSSM) (Gribskov et al., 1987) and possibly profile hidden Markov model (profile HMM) (Eddy, 1999). The profiles need to be re-arranged in the same striped pattern as the query profiles in order to work with this implementation. In a further embodiment, sometimes a quick search without alignment is performed and the results are then reviewed and certain results are then processed for alignment since alignment takes longer.

Another possible use for the algorithm described herein, in addition to database searches, would be for aligning two sequences. Other software packages use a SIMD implementation to find high scoring matches and then use a scalar Smith-Waterman to align the two sequences. One implementation of the present invention could easily be modified to find the high score and the location of the scoring sequence. By using a triple H buffer, where the third H buffer is used to save the column with the highest score. When a new maximum is found, the current H buffer is saved along with the X coordinate of the column. When the database sequence has been completely processed, the save H buffer is scanned for the Y coordinate of the maximum score. The location could then be used in the Hirschberg algorithm (Chao et al., 1994) to align the two sequences. This allows faster alignments of larger sequences in linear space.

Dynamic programming is used for global alignment (Needleman and Wunsch, 1970) as well as local alignment. Other uses include assembling DNA sequence data from the fragments from automated sequencing machines (Anson and Myers, 1997), and to determine the intron/exon structure of eukaryotic genes (Gelfand and Roytberg, 1993). It is also used to predict the secondary structure of functional RNA genes or regulatory elements (Zuker, 1989). All of these problems benefit from an efficient SIMD implementation of the dynamic programming algorithm.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for a database search, comprising:
a striped Smith-Waterman implementation for comparing a query sequence to a database sequence, wherein said query sequence and said database sequence form a matrix having a plurality of vectors arranged in a linear fashion, said vectors being parallel to said query sequence, and wherein a plurality of elements of said query sequence are reordered in a striped pattern, and a Smith-Waterman algorithm is used to generate a set of dynamic programming results for further processing.

2. The system of claim 1, wherein the striped pattern comprises a plurality of partitions, wherein a length of said query sequence is divided by an equal number of partitions, wherein the number of partitions is equal to the number of elements being processed in the vectors, and wherein the n^{th} vector processes the n^{th} values from each partition.

3. The system of claim 1, wherein a query profile is pre-calculated once for the database search by reordering a set of weights to match the striped pattern over which the query sequence is processed.

4. The system of claim 1, wherein an F value is set to an initial value for out of order calculations.

5. The system of claim 4, further comprising a secondary loop to correct errors introduced by the initial F value.

6. The system of claim 1, further comprising scoring wherein the scoring uses a scoring function selected from one of the group consisting of: block substitution, position-specific scoring matrices (PSSM) and profile hidden Markov model (profile HMM).

7. The system of claim 5, wherein the scoring generates a table of weights using a substitution matrix, and a scoring profile is indexed by a query sequence position and a database sequence symbol.

8. The system of claim 1, wherein the database search is used for at least one of database searching and aligning sequences.

9. The system of claim 1, wherein the query sequence, reordered in the striped pattern, is used to generate a shuffle profile wherein said shuffle profile creates a substitution matrix to match the striped pattern of the query string.

10. The system of claim 9, wherein a row of the substitution matrix matches a current database sequence symbol and the shuffle pattern is indexed by a query sequence position, wherein computing of H consists of a single load from memory of a shuffle vector from the shuffle profile.

11. A method for dynamic programming, comprising:
initializing memory for a scoring profile;
building said scoring profile based on a query string by reordering a plurality of elements of said query string in a striped pattern, wherein said scoring profile is used once for an entire search;
performing the dynamic programming processing in said striped pattern; and reporting a set of scoring results from said dynamic programming for interpretation or alignment.

12. The method according to claim 11, further comprising setting initial values for each element in an F vector that has not been calculated.

13. The method according to claim 12, further comprising correcting errors based on said initial values that are incorrect.

14. The method according to claim 11, further comprising computing at least one of an optimal local alignment and a global alignment.

15. The method according to claim 11, wherein said dynamic programming uses an algorithm selected from the group consisting of: Smith-Waterman, Needleman-Wunsch, Gotoh, and Viterbi.

16. A computer storage medium readable by a computer system having computer-executable components for a database search, comprising:
processing a plurality of vectors arranged in a linear fashion, wherein said vectors are parallel to a query sequence;
building a scoring profile based on said query sequence by reordering a plurality of elements of said query sequence to match a striped pattern, wherein said scoring profile is used once for said database search;
dynamic programming of said striped pattern to produce a set of scoring results; and
reporting said scoring results.

17. The medium according to claim 16, wherein said dynamic programming uses an algorithm selected from the group consisting of: Smith-Waterman, Needleman-Wunsch, Gotoh, and Viterbi.

18. The medium according to claim 16, wherein the striped pattern comprises of plurality of partitions, wherein a length of said query sequence is divided by an equal number of partitions, wherein the number of partitions is equal to the number of elements being processed in the vectors, and wherein the nth vector processes the nth values from each partition.

19. The medium according to claim 16, further comprising reporting of a location of a scoring sequence of said scoring results.

20. The medium according to claim 16, wherein data dependencies of said vectors are moved out of an inner loop and done just once in an outer loop.
